(19) United States
(12) Patent Application Publication
(10) Pub. No.: US 2010/0243003 A1
(43) Pub. Date: Sep. 30, 2010

(54) APPARATUS AND METHOD FOR CLEANING SEMICONDUCTOR SUBSTRATE

(76) Inventor: Yoshihiro Ogawa, Yokkaichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/726,423

(22) Filed: Mar. 18, 2010

(30) Foreign Application Priority Data
Mar. 25, 2009 (JP) 2009-73657

(51) Int. Cl. B08B 3/12

(52) U.S. Cl. 134/34; 134/184

(57) ABSTRACT

A semiconductor substrate cleaning apparatus which cleans a semiconductor substrate with a chemical solution, includes a water concentration detecting device which detects water concentration of the chemical solution, an ultrasonic transducer which applies ultrasonic waves to the chemical solution or the semiconductor substrate to execute ultrasonic cleaning, and a control device which turns on and off the ultrasonic transducer based or changes a cleaning condition for the ultrasonic cleaning based on the water concentration detected by the water concentration detecting device.

### CROSS-REFERENCE TO RELATED APPLICATIONS

This application is based on and claims the benefit of priority from the prior Japanese Patent Application No. 2009-73657, filed on Mar. 25, 2009, the entire contents of which are incorporated herein by reference.

### BACKGROUND

1. Field

The present invention relates to an apparatus and method for cleaning a semiconductor substrate, which removes particles (resist residues, for example) adherent to a surface of a semiconductor substrate.

2. Related Art

Ultrasonic cleaning apparatuses are known as an example of apparatus for removing particles adherent to the surface of a semiconductor substrate. Japanese patent application publication JP-A-2001-284306 discloses one of such ultrasonic cleaning apparatuses. It is also known that a high particle removal effect can be achieved when semiconductor substrates are cleaned by the ultrasonic cleaning apparatus. However, with progress in the pattern microstructurization, a microscopic pattern is sometimes damaged by ultrasonic waves when a semiconductor substrate formed with the microscopic pattern is ultrasonic-cleaned.

Furthermore, a semiconductor substrate is sometimes formed with microscopic holes, such as contact holes, each of which has a high aspect ratio. The distance between the holes is reduced with progress in the microstructurization of the holes. In this case, there is a possibility that the microscopic holes may be damaged by the ultrasonic waves when the semiconductor substrate is ultrasonic-cleaned.

### SUMMARY

According to one aspect of the present invention, there is provided a semiconductor substrate cleaning apparatus which cleans a semiconductor substrate with a chemical solution, the apparatus comprising a water concentration detecting device which detects concentration of water contained in the chemical solution; an ultrasonic transducer which applies ultrasonic waves to the chemical solution or the semiconductor substrate to execute ultrasonic cleaning; and a control device which turns on and off the ultrasonic transducer or changes a cleaning condition for the ultrasonic cleaning based on the water concentration detected by the water concentration detecting device.

According to another aspect of the invention, there is provided a method of cleaning a semiconductor substrate with a chemical solution, comprising detecting concentration of water contained in the chemical solution by a water concentration detecting device; and controlling an ultrasonic transducer so that the ultrasonic transducer is turned on and off based on the detected water concentration, the ultrasonic transducer applying ultrasonic waves to the chemical solution or the semiconductor substrate.

There is also provided a method of cleaning a semiconductor substrate with a chemical solution, comprising detecting concentration of water contained in the chemical solution by a water concentration detecting device; and executing control so that a cleaning condition for ultrasonic cleaning is changed based on the detected water concentration, said ultrasonic cleaning being carried out by an ultrasonic transducer applying ultrasonic waves to the chemical solution or the semiconductor substrate.

### BRIEF DESCRIPTION OF THE DRAWINGS

FIG. 1 is a block diagram of a semiconductor substrate cleaning apparatus in accordance with one embodiment;

FIGS. 2A, 2B and 2C are longitudinally sectional views of a semiconductor substrate, showing the operation of the cleaning apparatus when a hole is cleaned; and

FIG. 3 is a view similar to FIG. 1, showing the cleaning apparatus of a second embodiment.

### DETAILED DESCRIPTION

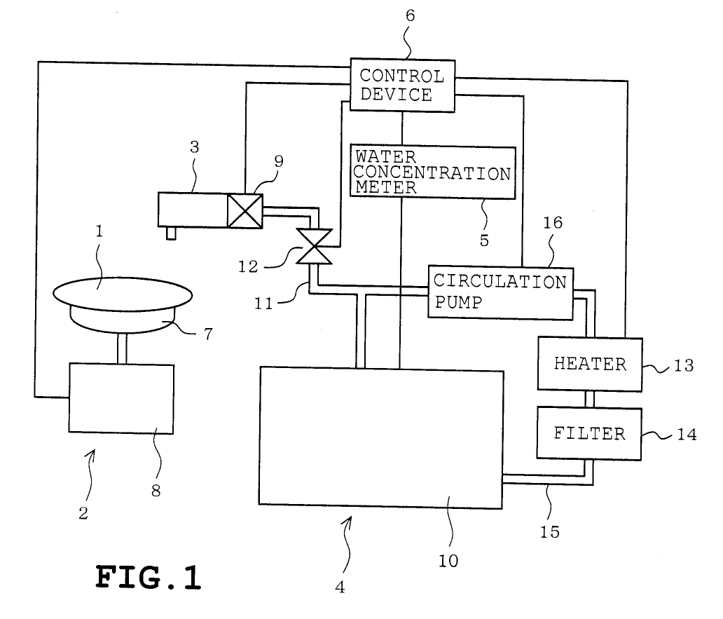

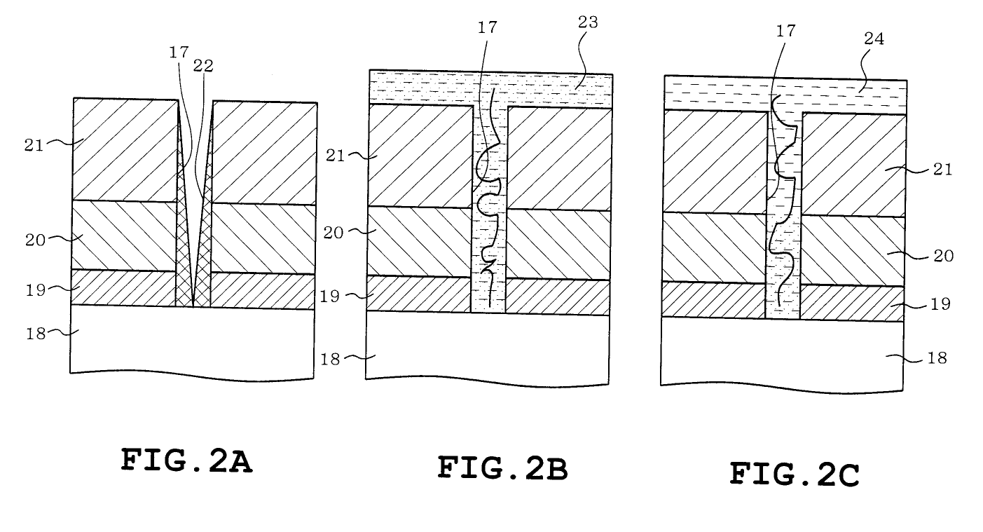

A first embodiment will be described with reference to FIGS. 1 to 2C. The embodiment is directed to a single wafer ultrasonic cleaning apparatus. Referring to FIG. 1, the ultrasonic cleaning apparatus includes a rotating unit 2 which rotates a wafer 1 (a semiconductor substrate), a discharge nozzle 3 which discharges a chemical solution such as a cleaning liquid or rinse agent onto the wafer 1, a chemical solution supply unit 4 which supplies the chemical solution to the discharge nozzle 3, a water concentration meter 5 serving as a water concentration detecting device which detects concentration of water contained in the chemical solution in the chemical solution supply unit 4, and a control device 6 controlling the entire cleaning apparatus.

The rotating unit 2 includes a rotary table 7 on which the wafer 1 is placed to be supported and an electric motor 8 which drives the rotary table 7. The control device 6 controls start/stop and a rotational speed of the motor 8. The discharge nozzle 3 includes an ultrasonic transducer 9 which applies ultrasonic waves to the chemical solution supplied from the chemical solution supply unit 4. The control device 6 on-off controls the ultrasonic transducer 9 and further controls an oscillation output of the ultrasonic transducer 9. The discharge nozzle 3 is moved in the x, y and z directions by an xyz moving mechanism (not shown) thereby to be located at a predetermined height above the wafer 1.

The chemical solution supply unit 4 includes a storage 10 storing the chemical solution, a circulation pump 16 circulating the chemical solution in the storage 10 through a circulation path 15 provided with a heater 13 and a filter 14, and a supply path 11 which is diverged from the circulation path 15 to deliver the chemical solution in the storage 10 through a valve 12 into the discharge nozzle 3. The circulation pump 16 and the heater 13 are individually controlled by the control device 6 so as to be energized and de-energized. The valve 12 is controlled by the control device 6 so as to be opened and closed. In this construction, when circulated through the circulation path 15, the chemical solution in the storage 10 is heated by the heater 13 thereby to be retained at a predetermined temperature and is also passed through the filter 14 so that foreign matter such as dust is removed from the chemical solution. A temperature sensor (not shown) is provided for detecting a temperature of the chemical solution in the storage 10 or in the circulation path 15, thereby generating a detection signal indicative of the detected temperature. The detection signal is delivered to the control device 6.

The water concentration meter 5 comprises an electrical resistivity meter, an absorption spectrometer or the like and detects a concentration of water contained in the chemical solution in the storage 10, delivering a detection signal indicative of the detected water concentration to the control device 6. A detecting part of the water concentration meter 5 may be located in the storage 10 or the discharge nozzle 3 or in the midst of the circulation path 15 or the supply path 11. When the detecting part is located in the discharge nozzle 3, it is desirable to position the detecting part so that the chemical solution is detected immediately before discharge onto the wafer 1.

The control device 6 comprises a computer, for example, and controls the motor 8 of the rotating unit 2 so that the turn table 7 is rotated at a predetermined rotational speed. The control device 6 further controls the heater 13 and the circulation pump 16 of the chemical solution supply unit 4 so that the chemical solution in the storage 10 is retained at a predetermined temperature. The control device 6 still further controls the valve 12 of the chemical solution supply unit 4 so that the valve 12 is opened or closed, whereby the chemical solution in the storage 10 is delivered into the discharge nozzle 3 and discharged onto the wafer 1 or is stopped being discharged.

Furthermore, the control device 6 drives the ultrasonic transducer 9 of the discharge nozzle 3 so that ultrasonic waves are applied to the chemical solution in the discharge nozzle 3, whereby the chemical solution having been subjected to the ultrasonic waves is discharged from the discharge nozzle 3 onto the wafer 1. The ultrasonic cleaning is thus executed. The control device 6 still further turns on and off the ultrasonic transducer 9, based on the detection signal delivered from the water concentration meter 5, that is, based on the concentration of water contained in the chemical solution.

As the result of an experiment, the inventor confirms that an organic solvent such as isopropyl alcohol (IPA) or hydrofluoroether (HFE), or an inorganic chemical solution such as phosphoric acid (H₃PO₄), sulfuric acid (H₂SO₄), acetic acid (CH₃COOH) or the like is effective as the chemical solution (cleaning liquid) when the chemical solution to which the ultrasonic waves have been applied is discharged from the discharge nozzle 3 onto the wafer 1 for execution of the ultrasonic cleaning. The inventor also confirms that when the chemical solution has no water content, a fine pattern formed in a surface of the wafer 1 is prevented from being damaged, and further that when various causes as will be described later result in a certain amount of water subsequently, that is, the water concentration in the chemical solution is increased in some measure, the fine pattern formed in the surface of the wafer 1 is damaged.

The inventor still further confirms, by the experiment or the like, that about 20% of the fine pattern is damaged when the water concentration of the chemical solution is increased to about 20% by weight in the case where sulfuric acid (H₂SO₄) is used as a main component of the chemical solution, for example. The inventor additionally confirms, by the experiment or the like, that an incidence rate of damage of the fine pattern is increased with further increase in the water concentration, and further that about 100% of the fine pattern is damaged when the water concentration is increased to about 40% by weight.

In view of the foregoing experimental result, the control device 6 is designed to control the cleaning apparatus of the embodiment so that when the water concentration of the chemical solution is increased above a reference value (20% by weight when sulfuric acid (H₂SO₄) is used, for example), the ultrasonic transducer 9 is turned off so that application of ultrasonic waves onto the chemical solution in the discharge nozzle 3 is stopped. Consequently, since a normal cleaning by the use of the chemical solution is carried out, the fine pattern can be prevented from being damaged as much as possible. The control device 6 is also arranged to control the cleaning apparatus so that when the water concentration of the chemical solution is reduced to or below the reference value subsequent to the stop of application of ultrasonic waves to the chemical solution, the ultrasonic transducer 9 is re-turned on so that ultrasonic waves are applied to the chemical solution in the discharge nozzle 3 again.

As an example of re-applying ultrasonic waves to the chemical solution, all or part of the chemical solution whose water concentration has been increased is replaced by new chemical solution (namely, chemical solution which is water-free or has an extremely low water concentration) so that the water concentration is reduced to or below the reference value. When the water concentration has been reduced to or below the reference value, the control device 6 turns on the ultrasonic transducer 9 to re-execute the ultrasonic cleaning. The aforesaid reference value of the water concentration for determination of on-off control of the ultrasonic transducer 9 is desirably set to a suitable value according to an oscillation output or oscillation frequency of the ultrasonic transducer 9, a type of chemical solution, a temperature of the chemical solution, intervals of the fine pattern (the width of space in a line-and-space pattern, for example), or the like.

A main factor which increases the water concentration in the chemical solution will now be described. Firstly, variations in the temperature of the chemical solution intensify a water-absorbing property of the chemical solution, whereupon moisture contained in the atmosphere becomes easy to be entrained into the chemical solution. This results in an increase in the water concentration of the chemical solution. In this case, particularly when sulfuric acid (H₂SO₄) is used as the chemical solution, the moisture in the atmosphere easily tends to be mixed into the chemical solution since the sulfuric acid has water absorbability. Furthermore, when the above-described ultrasonic cleaning is executed after a water-soluble chemical solution treatment or a water rinse is carried out, moisture is mixed into the chemical solution bit by bit, whereupon the water concentration of the chemical solution is increased in some case.

When the water concentration of the chemical solution is increased above the water concentration at which the fine pattern is damaged, the power supply applied to the ultrasonic transducer 9 is turned off so that application of ultrasonic waves is stopped in the foregoing embodiment. However, a cleaning condition of the ultrasonic cleaning may be changed, instead. For example, the control device 6 may control the cleaning apparatus so that an oscillation output of the ultrasonic transducer 9 is reduced so that output power of the ultrasonic waves to be applied to the chemical solution may be changed. A concrete amount of power reduction regarding the ultrasonic output power applied to the chemical solution may suitably be set by conducting an experiment or the like. On the other hand, when an oscillation frequency of the ultrasonic transducer 9 is variable, the frequency of the ultrasonic transducer 9 may be increased so that damage of the fine pattern is suppressed.

As another example of changing the cleaning condition of the ultrasonic cleaning, the valve 12 may be closed so that the supply of chemical solution to the discharge nozzle 3 is stopped, instead of turning off the ultrasonic transducer 9. And then, the chemical solution in the storage 10 is replaced by a new water-free chemical solution. The valve 12 may be re-opened after the control device 6 has adjusted via the heater 13 the temperature of the new chemical solution, whereby the chemical solution is supplied through the supply path 11 to the discharge nozzle 3.

Furthermore, the chemical solution is disposed of after having been discharged from the discharge nozzle 3 onto the wafer 1 in the foregoing embodiment. However, the chemical solution having been discharged onto the wafer 1 may be retrieved thereby to be returned to the chemical solution supply unit 4 for circulation, instead.

The working of the ultrasonic cleaning apparatus will be described in the following with reference to FIGS. 2A to 2C. In the following description, a fine deep-grooved hole (a contact hole, for example) 17 formed in the surface of the wafer 1 will be cleaned. Referring to FIG. 2A, a plurality of films 19, 20 and 21 are stacked sequentially on an upper surface of the silicon substrate 18. The hole 17 is formed through the stacked films 19 to 21 by a reactive ion etching (RIE) process, for example. Apart of the upper surface of the silicon substrate 18 is exposed through the hole 17, thereby constituting the bottom of the hole 17. A reactive product 22 adheres to an inner periphery and the bottom of the hole 17. The hole 17 has a depth of not less than 1 μm, for example. An amount of the reactive product 22 adherent to the periphery and bottom of the hole 17 is rendered larger in principle as the hole 17 to be formed becomes deep.

Next, the ultrasonic cleaning is executed by the above-described ultrasonic cleaning apparatus in order that the reactive product 22 in the hole 17 may be removed. Application of ultrasonic waves accelerates penetration of the chemical solution into the fine deep-grooved hole 17. A mixed liquid of isopropyl alcohol (IPA) and hydrofluoric acid (HF) is used as the chemical solution in this case. The chemical solution (the mixed liquid) has a smaller surface tension than water and its value is equal to or below one third of the surface tension of water. As a result, when the ultrasonic cleaning is carried out with the aforesaid mixed liquid, the chemical solution is easy to penetrate into the interior of the hole 17 even when the hole 17 is fine and deep-grooved, as shown in FIG. 2B. Moreover, the reactive product 22 can sufficiently be removed since the ultrasonic cleaning enhances the chemical reaction of removing the reactive product 22 by the chemical solution 23.

In addition, a chemical solution having a smaller surface tension can also be prepared even when HFE or a mixed liquid of IPA and HFE is used instead of IPA. Furthermore, the reactive product 22 in the hole 17 can sufficiently be removed even when ammonium fluoride (NH₄F), a mixture of HF and NH₄F or the like is used as the fluorine compound instead of HF.

Subsequently, the chemical solution is replaced by another chemical solution 24 containing IPA (a rinse liquid) as a main component and the ultrasonic cleaning is executed with the chemical solution 24 so that the hole 17 is rinsed, as shown in FIG. 2C. In this case, a mixed liquid (the chemical solution with the reactive product 22 being dissolved therein) remains on the bottom of the hole 17. The ultrasonic cleaning can facilitate a reaction of agitating and replacing the mixed liquid by IPA. Consequently, the interior of the hole 17 including the bottom can sufficiently be rinsed, whereby a normal contact interface can be obtained on the bottom of the hole 17. A drying step is carried out after the above-described rinse step to remove the chemical solution.

When the water concentration of the chemical solution is increased to exceed the predetermined reference value during the ultrasonic cleaning as shown in FIGS. 2B and 2C, the control device 6 turns off the ultrasonic transducer 9 thereby to stop the application of ultrasonic waves to the chemical solution in the discharge nozzle 3. Consequently, since refinement of the hole 17 is accelerated, the fine hole 17 can reliably be prevented from being damaged by the ultrasonic waves even when the interval between the holes 17 is narrow.

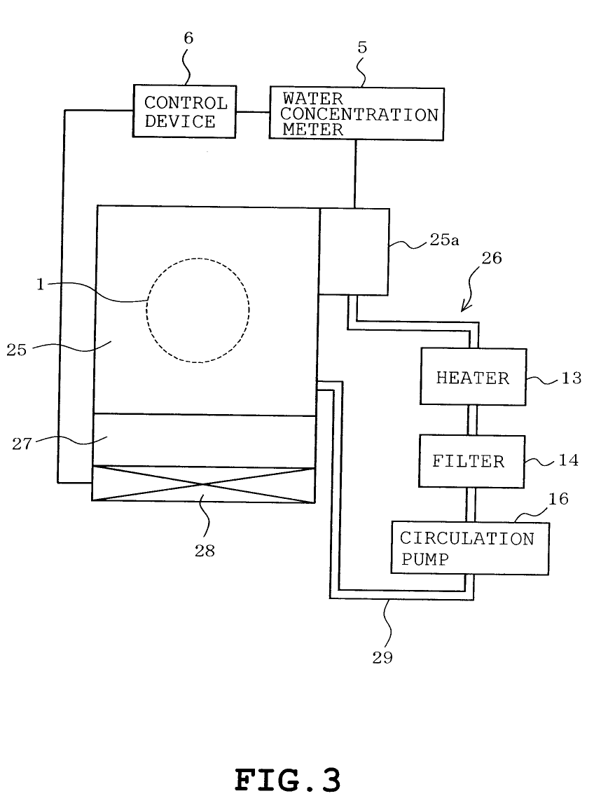

FIG. 3 illustrates a second embodiment. Identical or similar parts in the second embodiment are labeled by the same reference symbols as those in the first embodiment. The second embodiment is directed to a batch-type ultrasonic cleaning apparatus which cleans a plurality of wafers 1 simultaneously. The ultrasonic cleaning apparatus of the second embodiment includes a treating bath 25 in which a plurality of wafers 1 accommodated in a wafer cassette (not shown) are treated, a circulating supply unit 26 which supplies the chemical solution to the treating bath 25 by circulation, the water concentration meter 5 which detects the concentration of water contained in the treating bath 25, and the control device 6 controlling the entire cleaning apparatus.

An indirect bath 27 is provided under the treating bath 25 to circulate water. The indirect bath 27 has a bottom on which an ultrasonic transducer 28 is mounted. When the ultrasonic transducer 28 is controlled by the control device 6 so as to be energized, ultrasonic waves generated by the ultrasonic transducer 28 are transmitted via the indirect bath 27 to the chemical solution in the treating bath 25, thereby being applied to the chemical solution. As a result, the plural wafers 1 are simultaneously ultrasonic-cleaned in the treating bath 25.

The circulating supply unit 26 includes the circulation pump 16, the filter 14, the heater 13, and a circulation path 29 which connects the circulation pump 16, the filter 14, the heater 13 and the treating bath 25. The circulation pump 16 and the heater 13 are controlled by the control device 6 so as to be energized, so that the chemical solution in the treating bath 25 is circulated through the circulation path 29 and so that the chemical solution in the treating bath 25 is retained at a predetermined temperature. A temperature sensor (not shown) is provided for detecting a temperature of the chemical solution in the treating bath 25 or in the circulation path 29, thereby generating a detection signal indicative of the detected temperature of the chemical solution. The detection signal is delivered to the control device 6.

The water concentration meter 5 detects concentration of water contained in the chemical solution in the treating bath 25. The water concentration meter 5 includes the detecting part provided in a detection bath 25a communicating with the treating bath 25 on an upper side of the treating bath 25. Alternatively, the detecting part of the water concentration meter 5 may be provided in the treating bath 25, in the middle of the circulation path 29 or in a bypath (not shown) diverged from the circulation path 29.

When determining that the water concentration of the chemical solution has exceeded the threshold, based on the detection signal delivered from the water concentration meter 5 (the concentration of water contained in the chemical solution), the control device 6 turns off the ultrasonic transducer 28. When determining that the water concentration of the chemical solution has been reduced to or below the threshold, the control device 6 turns on the ultrasonic transducer 28.

The other arrangement of the ultrasonic cleaning apparatus is substantially the same as that in the first embodiment. Accordingly, the second embodiment can achieve substantially the same effect as the first embodiment. Thus, when the interior of the fine deep-grooved hole 17 as shown in FIGS. 2A to 2C is ultrasonic-cleaned by the ultrasonic cleaning apparatus of the second embodiment, the second embodiment can achieve substantially the same effect as the first embodiment.

The foregoing embodiments should not be restrictive but can be modified or expanded as follows. The ultrasonic transducer 9 or 28 is mounted on the discharge nozzle 3 or the indirect bath 27 to apply ultrasonic waves to the chemical solution in the first or second embodiment. However, the ultrasonic transducer may be disposed above the wafer 1 so as to be in proximity to the wafer 1, and ultrasonic waves may be applied to the chemical solution while a space between the wafer 1 and the ultrasonic transducer is filled with the chemical solution (referred to as “proximity ultrasonic cleaning system”). Furthermore, the ultrasonic transducer may be disposed in proximity to the wafer to apply ultrasonic waves to the wafer while a space at the wafer backside (non-device side) is filled with the chemical solution whereas the chemical solution may be discharged from the nozzle onto the wafer surface side. Thus, the ultrasonic cleaning may be carried out for both sides of the wafer. In this case, when the water concentration of the chemical solution is increased, the cleaning condition of the ultrasonic cleaning may be changed so that the supply of chemical solution to the wafer surface side is stopped, whereby the fine pattern on the device side can be prevented from being damaged. Furthermore, the ultrasonic transducer may be mounted directly on the treating bath 25 with the result that the indirect bath 27 may be eliminated.

In each embodiment, the mixed liquid of IPA or HFE and HF or NH₄F, which liquid has a smaller surface tension than water, is used as the chemical solution when the fine and deep-grooved hole is ultrasonic-cleaned. However, the mixed liquid of IPA or HFE and HF or NH₄F, which liquid has a smaller surface tension than water, is used as the chemical solution when a fine line-and-space pattern formed on the upper surface of the wafer is ultrasonic-cleaned. Consequently, since the chemical solution is easy to penetrate into the space of the fine line-and-space pattern, a desirable ultrasonic cleaning can be carried out.

The foregoing description and drawings are merely illustrative of the principles and are not to be construed in a limiting sense. Various changes and modifications will become apparent to those of ordinary skill in the art. All such changes and modifications are seen to fall within the scope as defined by the appended claims.

What is claimed is:

1. A semiconductor substrate cleaning apparatus which cleans a semiconductor substrate with a chemical solution, the apparatus comprising:
a water concentration detecting device which detects concentration of water contained in the chemical solution;
an ultrasonic transducer which applies ultrasonic waves to the chemical solution or the semiconductor substrate to execute ultrasonic cleaning; and
a control device which turns on and off the ultrasonic transducer or changes a cleaning condition for the ultrasonic cleaning based on the water concentration detected by the water concentration detecting device.

2. The cleaning apparatus according to claim 1, further comprising a rotating unit which is rotated with the semiconductor substrate placed thereon, and a discharge nozzle which discharges the chemical solution onto the semiconductor substrate, wherein the ultrasonic transducer is mounted on the discharge nozzle.

3. The cleaning apparatus according to claim 2, further comprising a chemical solution supply unit which supplies the chemical solution to the discharge nozzle, the chemical solution supply unit including a storage which stores the chemical solution and a circulation pump which circulates the chemical solution stored in the storage through a circulation path provided with a heater and a filter.

4. The cleaning apparatus according to claim 1, further comprising a treating bath in which the plural semiconductor substrates are cleaned and a circulating supply unit which circularly supplies the chemical solution to the treating bath.

5. The cleaning apparatus according to claim 4, further comprising an indirect bath provided under the treating bath so that water is circulated therethrough, and the ultrasonic transducer is mounted on the indirect bath.

6. The cleaning apparatus according to claim 1, wherein the ultrasonic transducer is located in proximity to a surface of the semiconductor substrate, and the ultrasonic waves are applied to the chemical solution while a space between the surface of the semiconductor substrate and the ultrasonic transducer is filled with the chemical solution.

7. The cleaning apparatus according to claim 1, wherein the chemical solution contains as a main component isopropyl alcohol, hydrofluoroether, phosphoric acid, sulfuric acid, acetic acid or a mixture of two or more of isopropyl alcohol, hydrofluoroether, phosphoric acid, sulfuric acid and acetic acid.

8. The cleaning apparatus according to claim 1, wherein the control device controls the ultrasonic transducer so that the ultrasonic transducer is turned off when the detected water concentration is higher than a reference value.

9. The cleaning apparatus according to claim 8, wherein the control device controls the ultrasonic transducer so that the ultrasonic transducer is re-turned on when the detected water concentration has been reduced to or below the reference value after turn-off of the ultrasonic transducer.

10. A method of cleaning a semiconductor substrate with a chemical solution, comprising:
detecting concentration of water contained in the chemical solution by a water concentration detecting device; and
controlling an ultrasonic transducer so that the ultrasonic transducer is turned on and off based on the detected water concentration, the ultrasonic transducer applying ultrasonic waves to the chemical solution or the semiconductor substrate.

11. The cleaning method according to claim 10, wherein the chemical solution has a lower surface tension than water.

12. The cleaning method according to claim 11, wherein the chemical solution contains at least one of isopropyl alcohol and hydrofluoroether.

13. The cleaning method according to claim 10, wherein the ultrasonic transducer is turned off when the detected water concentration is higher than a reference value.

14. The cleaning method according to claim 13, wherein the ultrasonic transducer is re-turned on when the detected water concentration has been reduced to or below the reference value after turn-off of the ultrasonic transducer.

15. A method of cleaning a semiconductor substrate with a chemical solution, comprising:
detecting concentration of water contained in the chemical solution by a water concentration detecting device; and
executing control so that a cleaning condition for ultrasonic cleaning is changed based on the detected water concentration, said ultrasonic cleaning being carried out by applying ultrasonic waves to the chemical solution or the semiconductor substrate.

16. The cleaning method according to claim 15, wherein the chemical solution has a lower surface tension than water.

17. The cleaning method according to claim 16, wherein the chemical solution contains at least one of isopropyl alcohol and hydrofluoroether.

18. The cleaning method according to claim 15, wherein the cleaning condition for the ultrasonic cleaning includes an oscillation output of an ultrasonic transducer applying the ultrasonic waves to the chemical solution or the semiconductor substrate.

19. The cleaning method according to claim 15, wherein the cleaning condition for the ultrasonic cleaning includes an oscillation frequency of an ultrasonic transducer applying the ultrasonic waves to the chemical solution or the semiconductor substrate.

20. The cleaning method according to claim 15, wherein when the cleaning condition for the ultrasonic cleaning is changed, supply of the chemical solution is stopped and new water-free chemical solution is supplied, instead.
